(19) United States
(12) Patent Application Publication
(10) Pub. No.: US 2010/0081540 A1
(43) Pub. Date: Apr. 1, 2010

(54) COMBINED POWER TRANSMISSION AND DRIVE UNIT FOR APPLICATION IN HYBRID SYSTEMS AND A HYBRID SYSTEM

(75) Inventors: Thorsten KRAUSE, Buehl (DE); Benjamin VOEGTLE, Karlsruhe (DE); Heiko MAGERKURTH, Freiburg im Breisgau (DE)

Correspondence Address: SIMPSON & SIMPSON, PLLC, 5555 MAIN STREET, WILLIAMSVILLE, NY, 14221-5406, US

(73) Assignee: LUK LAMELLEN UND KUPPLUNGSBAU BETEILIGUNGS KG, Buehl (DE)

(21) Appl. No.: 12/566,230

(22) Filed: Sep. 24, 2009

(30) Foreign Application Priority Data
Sep. 26, 2008 (DE) 102008049264.7
Nov. 24, 2008 (DE) 102008058708.7

(51) Int. Cl. B60K 6/22

(52) U.S. Cl. 477/3; 903/915

(57) ABSTRACT

A combined power transmission and drive unit (1) for the application in hybrid systems (2) between a first engine (3) and a transmission device, in particular transmission (4), comprising at least an input (33) capable of connection with the engine (3), a power transmission device (6), whose output (A) is connected with a transmission input shaft (5), of a device (14) for at least selective disconnection/connection of the power flow from the input (33) of the combined power transmission and drive unit (1) to the power transmission device (6), and an electric machine (7), comprising at least a rotor (12) that is connected non-rotatably with the input (E) of the power transmission device (6), wherein the rotor is centered and supported on the housing of the power transmission device.

### CROSS-REFERENCE TO RELATED APPLICATIONS

This patent claims priority of German Patent Application Nos. 10 2008 049 264.7, filed on Sep. 26, 2008, and 10 2008 058 708.7, filed on Nov. 24, 2008, which applications are incorporated herein by reference.

### FIELD OF THE INVENTION

The present invention relates to a combined power transmission and drive unit for application in hybrid systems, between a first engine and a transmission device, in particular a transmission comprising at least an input connectable with the engine, a power transmission device in which the output is connected with a transmission input shaft, a device for at least selective disconnection/connection of the power flow to the input of the power transmission device and an electric machine comprising at least a rotor that is connected non-rotatably with the input of the power transmission device. The present invention further relates to a hybrid system, comprising a first engine and a combined power transmission and drive unit connected downstream of the latter.

### BACKGROUND OF THE INVENTION

Hybrid systems for the application in vehicles are known in a number of prior art designs. Common in all is that at least two different drive units are provided in the drive train, through which selective or combined driving can occur. Furthermore, in general, hybrid systems are conceived such that at least one of the engines is suitable, in deceleration operation and/or in braking operation, for converting mechanical energy into a different energy form, in particular in electric energy, and for feeding the energy into an accumulator. Such a hybrid system, for instance, is anticipated in the prior publication DE 103 10 831 A1. This reference discloses a combined power transmission and drive unit for application in hybrid systems, between a first engine and transmission disposed downstream. The combined power transmission and drive unit comprises a power transmission device that can be coupled with the transmission input shaft or that comprises the latter and a clutch device disposed between the latter and the engine, which allows or even interrupts the power flow from the engine to the power transmission device. Further provided is a second engine in the form of an electric machine, which comprises a rotor that can be coupled non-rotatably with the power transmission device. The latter is disposed upstream of the power transmission device, towards the transmission, viewed in power flow direction. A dual mass flywheel is provided in the power flow between the switchable clutch device and the first engine in which the input is coupled non-rotatably with the crankshaft. The transmission input shaft in this case is mounted on the crankshaft. The electric machine, viewed in axial direction, is disposed in the area around the extension of the switchable clutch device. For this purpose, the switchable clutch device is disposed almost within the diameter of the rotor of the electric machine. The rotor is connected non-rotatably with the housing of the clutch device or it forms an integral unit with the latter. The rotor is mounted directly on the housing of the clutch device. This allows a very space-saving formation of a hybrid system. The assembly can nevertheless be designed in a relatively complex manner. A further critical disadvantage is that the power transmission device and the switchable clutch device constitute devices which, during their operation, are surrounded by an operating medium or which require an operating medium in order to realize the mode of functioning, so that individual components are always wetted with operating medium or rotate in the latter. Owing to the depicted arrangement, also the electric machine is nonetheless exposed to the operating medium of the two units—power transmission device and switchable clutch device—in particular of the air gap between the rotor and stator required for induction, which can impair the mode of functioning. Furthermore, the angular displacements between the crankshaft of the engine and the transmission input shaft, in the depicted form, are not adjustable, hence is the reason why very high demands must be put on the accuracy of production of the individual components, which leads to the overall unit being more expensive. The function of individual components can only be tested after full assembly of the entire power transmission and drive unit.

### BRIEF SUMMARY OF THE INVENTION

The task of the invention is to achieve a simple bearing for the rotor of the electric machine in a combined power transmission and drive unit for application in hybrid systems between an engine and a transmission unit, in particular transmission.

This task is solved, according to the invention, by a combined power transmission and drive unit for application in hybrid systems between a first engine and a transmission device, in particular transmission, comprising at least an input connectable with the engine, a power transmission device whose output (A) is connected with a transmission input shaft and an electric machine, comprising at least a rotor that is connected non-rotatably with the input (E) of the power transmission device, wherein the rotor is supported on the housing of the power transmission device (and hence is centered).

### BRIEF DESCRIPTION OF THE DRAWINGS

The nature and mode of operation of the present invention will now be more fully described in the following detailed description of the invention taken with the accompanying drawing figures, in which:

FIGS. 1a and 1b show a basic design, in a schematically simplified illustration, of a combined power transmission and drive unit in a hybrid system according to the invention;

FIG. 2 illustrates a particularly advantageous embodiment of a combined power transmission and drive unit with the interfaces of the hybrid-systems;

FIGS. 3a to 3d illustrate, on the basis of the embodiment in accordance with FIG. 2, different modes of operation of a combined power transmission and drive unit;

FIG. 4 illustrates an embodiment of the power transmission device in dual-channel design based on a detail from FIG. 2;

FIG. 5 illustrates, on the basis of a section of a power transmission device, the embodiment in triple-channel design;

FIGS. 6a and 6b illustrate possible assignments of controls;

FIG. 7 shows, in a strongly schematized form, the present hybrid system with a bearing of the rotor in accordance with the exemplary embodiments of FIGS. 1 to 6b;

FIG. 8 shows, in a strongly schematized form, the present hybrid system with a modified rotor bearing; and,

FIG. 9 shows, in a strongly schematized form, one exemplary embodiment of the present hybrid system, wherein the rotor is attached directly to the converter housing.

### DETAILED DESCRIPTION OF THE INVENTION

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the preferred methods, devices, and materials are now described.

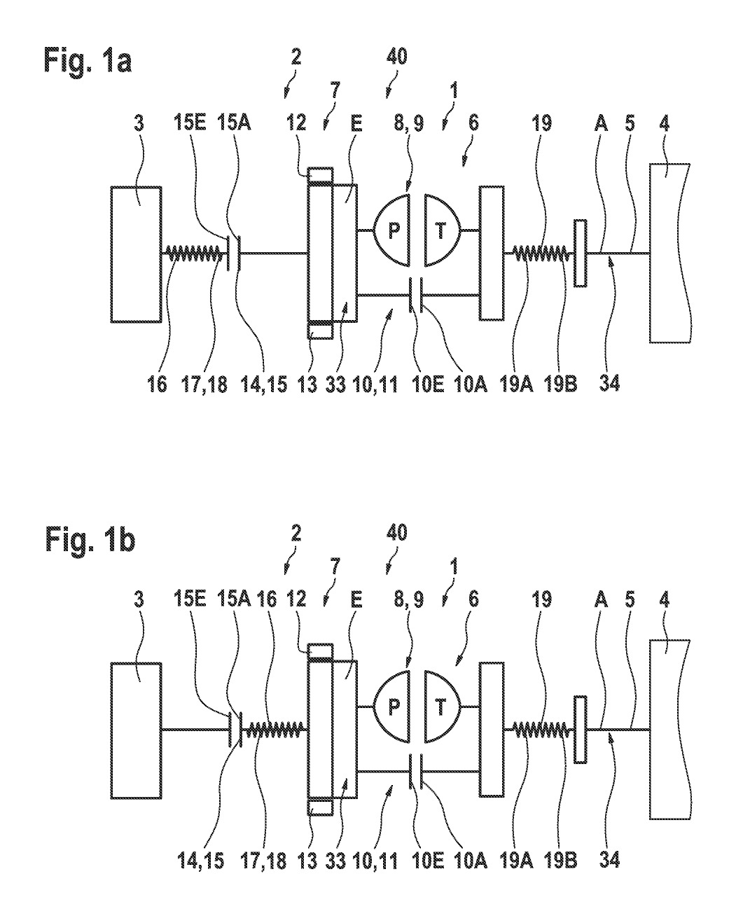

FIGS. 1a and 1b show, in a schematically simplified illustration, the basic design of a hybrid system 2 based on a section from a drive train 40 with a first engine 3 and a combined power transmission and drive unit 1, which comprises a further engine, in the form of an electric machine 7 comprising at least a rotor 12 and a stator 13. This corresponds to the second engine in the hybrid system 2. The combined power transmission and drive unit 1 comprises at least an input 33 and an output 34. The arrangement of the combined power transmission and drive unit 1 is provided in the power flow direction between the first engine 3 that is executed preferably in the form of an internal combustion engine, and a consumer, preferably in the form of transmission 4, in particular of a transmission input shaft 5. The second engine of the hybrid system 2 is at least executed as an electric machine 7 operable as a generator, preferably as a motor and generator. The combined power transmission and drive unit 1 further comprises a power transmission device 6, wherein in the hybrid system 2, the power transmission device 6 is operable both by means of the first engine 3 as well as the second engine in the form of the electric machine 7, and driving can proceed selectively by means of one of the engines 3, 7 or in parallel by means of both engines. The electric machine 7 for this purpose is operable as a motor. Furthermore, the electric machine 7 is operable preferably at least as a generator. Depending upon the mode of operation of the electric machine 7, different functions can be achieved, wherein, in the motorized operation, the function as a starter generator or as additional power feed to the first engine 3 is possible. In braking or deceleration operation, the electric machine 7 is operated preferably as a generator, wherein the mechanical energy that is transformed into electric energy can be fed into an accumulator or into consumer mains.

The power transmission device 6 is characterized by an input E and at least an output A, wherein the output A is formed either directly by the transmission input shaft 5 or is connected non-rotatably with the latter. The power transmission device 6 is connected non-rotatably with the electric machine 7, in particular with the rotor 12. This connection is established by means of the connection of the input E with the electric machine 7, wherein the rotor 12 is at least connected indirectly, preferably directly non-rotatably with the input E.

The power transmission device 6 comprises a hydrodynamic component 8. This features at least a primary wheel acting as an impeller P in traction operation during power transmission in the drive train 40 between the engine 3 and the transmission 4 and a secondary wheel acting as a turbine wheel T in this mode of operation. The impeller P of the hydrodynamic component 8 is connected non-rotatably with the input E of the power transmission device 6 or forms an integral component unit with the latter. The hydrodynamic component 8 can in the process be executed, in particular in the form of a hydrodynamic rotation speed/torque converter or solely in the form of a hydrodynamic clutch. In the first mentioned case, the hydrodynamic component 8 acts as transmission and serves for rotation speed/torque conversion. In the second case, the hydrodynamic component 8 is characterized by torque equilibrium between the impeller P and turbine wheel T only through the possibility of rotation speed conversion. In the embodiment as a hydrodynamic rotation speed/torque converter, at least a stator wheel is provided, which serves the rotation speed/torque conversion. In the case of power transmission through the hydrodynamic component 8, the latter describes a first hydrodynamic power branch 9.

Furthermore, the power transmission device 6 comprises a device 10 for bypassing the power transmission through the first power branch 9. Power transmission through a second, preferably mechanical power branch 11 is realized through the latter branch. The device 10, in this case, is preferably formed as a lock-up clutch. The latter is switchable and is preferably executed as a frictional clutch. Furthermore, also embodiments with synchronously switchable clutches are possible. The switchable clutch device comprises a first clutch part 10E, which is at least connected indirectly with the input E of the power transmission device 6 or forms the latter and a second clutch part 10A, which is at least connected indirectly with the output A of the power transmission device 6 or forms the latter, wherein the two clutch parts 10E and 10A can be brought together in active connection either directly or by further means of transmission.

By coupling the rotor 12 of the electric machine 7, the part of the individual power branches 9, 11 coupled with the input E of the power transmission device 6 can be stopped by braking.

The electric machine 7 is connected upstream of the power transmission device 6 in power flow direction between the engine 3 and transmission 4. In accordance with an advantageous embodiment, the system comprising the power transmission device 6 and the electric machine 7 can be coupled or uncoupled from the engine 3 selectively. The coupling or uncoupling takes place in the power flow upstream of the electric machine 7. The coupling/uncoupling is realized by means of a device 14 for selective connection/disconnection of the power flow between the engine 3 and power transmission device 6. The device 14 is preferably executed as a switchable clutch device 15. This is disposed between the engine 3 and the electric machine 7 as well as between the engine 3 and the input E of the power transmission device 6 and enables coupling or uncoupling of the engine 3 from the power transmission device 6. The switchable clutch device 15 comprises a first clutch part 15E that can be coupled at least indirectly or directly with the engine 3 and a second clutch part 15A connected with the power transmission device 6.

With regard to the first embodiment of the hybrid system 2 depicted in FIG. 1a, an apparatus 16 for damping vibrations is connected upstream of the switchable clutch device 15, which comprises means 17 for coupling damping and means 18 for torque transmission, in particular power transmission. Thus, the apparatus 16 for damping vibrations can be executed in different ways. The means 17 for coupling damping and the means 18 for power transmission can be realized by the same components or by different components, if necessary, also with at least partial function overlap. The apparatus 16 for damping vibrations thereby acts as an elastic clutch, meaning that, besides damping, torque is always transmitted as well. In accordance with FIG. 1a, the apparatus 16 is disposed between the first clutch part 15E of the switchable clutch device 15 and the engine 3, whereas, in contrast, in FIG. 1b, the arrangement is between the second clutch part 15A and the input E of the power transmission device 6. The second possibility has the advantage that the apparatus 16 in deceleration or braking operation acts as damper for the mass, which is formed by the power transmission device 6 and the electric machine 7, in particular rotor 12.

In accordance with a particularly advantageous embodiment, at least one, preferably two power braches 9, 11 of the power transmission device 6 are moreover disposed downstream and the damping means upstream of the transmission input shaft 5, in general in the form of an apparatus 19 for damping vibrations. This comprises means 19A for torque transmission and means 19B for damping vibrations.

The power transmission device 6, the electric machine 7 and the device 14 are disposed and executed in a manner that they can be jointed together respectively as preassembled component units to form a combined power transmission and drive unit 1, wherein the electric machine 7 is executed as a dry electric machine, thus, it does not run immersed in an operating medium of the other components of the combined power transmission and drive unit as well as of the adjoining transmission unit 4. For this, the power transmission device 6 and the device 14 are executed such that they are formed at least liquid-tight relative to the electric machine. This is realized by means of rotatable housing parts 23 and 25 that are sealed relative to the transmission input shaft 5, wherein the latter can also be combined to form a housing unit.

If the electric machine is executed as a dry-running machine, direct cooling is provided by air. Liquid cooling means can be realized by routing the cooling medium through the stator and/or also rotor.

FIGS. 1a and 1b show, in a schematically simplified illustration, particularly advantageous embodiments with respect to the arrangement and coupling of individual components of a hybrid system 2, which can be preassembled to form component units. The arrangement of individual apparatus 16 and 19 for damping vibrations takes place in the depicted embodiments, however, they can also be provided preferably optionally.

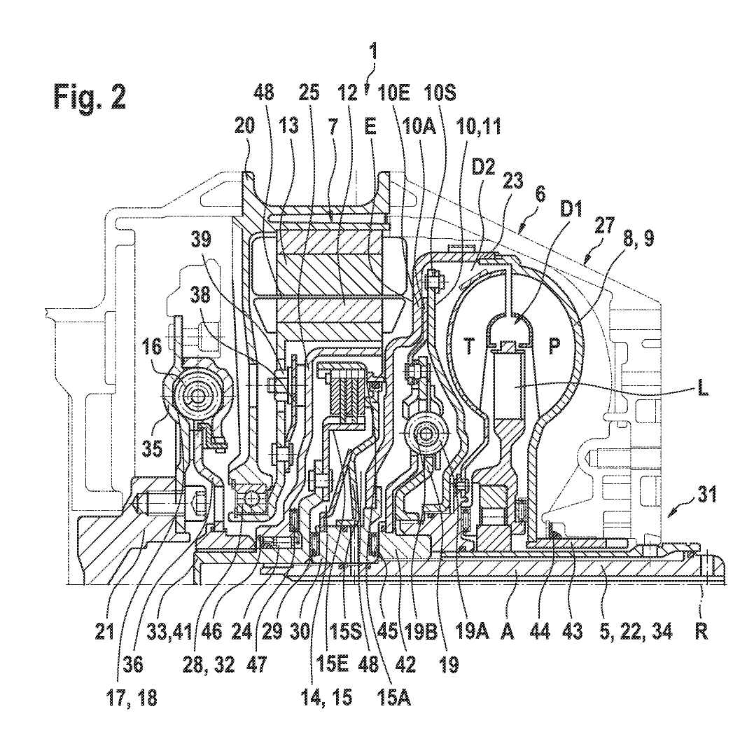

FIG. 2 illustrates a particularly advantageous design embodiment of a combined power transmission and drive unit 1 for application in a hybrid system 2, which can find application in a drive train 40 in accordance with FIGS. 1a, 1b. Individual components of the combined power transmission and drive unit 1, as preassembled units, can be tested separately and consecutively with the transmission 4 or together and connected with the engine 3. The assembly of this functional unit occurs preferably through the assembly of individual preassembled units, electric machine 7, power transmission device 6 and device 14 to form a functional unit of the combined power transmission and drive unit 1, wherein, first, the power transmission device 6 is connected with the transmission, subsequently the device 14 is stuck on and connected with the power transmission device 6 and only in the end is the connection with the electric machine established, particularly with the rotor.

The combined power transmission and drive unit 1 features at least an input 33, which can be coupled with the engine 3, furthermore, an output 34, which preferably comes from the output A of the power transmission device 6 and is very particularly preferred—formed by the transmission input shaft 5. The input 33 is formed by the device 14, in particular by the first clutch part 15E of the switchable clutch device 15 or by an element connected non-rotatably with the latter, here, by a hollow shaft closed on one side. The shaft is supported in the first clutch part and by the flexible connection, positioned between the rotor and power transmission device 6.

The embodiment described above in detail is common, so that the electric machine 7, as already explained, is formed as a dry-running electric machine, thus, it operates without an oil sump. The power transmission device 6 is formed as a wet-running device owing to its mode of functioning, in particular, owing to the hydrodynamic component 8. The device 14 in the form of the switchable clutch 15 is preferably, likewise, executed as a wet-running clutch device 15, thus, the components participating in power transmission are at least immersed in an operating fluid, in particular oil, during operation. This operating fluid remains inside these components even when inactivated. The formation of the power transmission device 6 as well as that of the device 14 for at least partial disconnection/connection of the power flow between the power transmission device 6 and the engine 3 (not depicted here) occurs preferably as independently testable component units, wherein both can be preassembled separately as component units or combined together as a unit. The latter embodiment has the advantage that components for both units can be used, in particular partition walls and housing components.

The device 14 in form of the switchable clutch device 15, in particular in the form of the wet clutch comprises a rotatable housing 25 that is executed in manner that is tight to pressure and liquid and disposed relative to the electric machine 7. The rotatable housing 25 is supported at least indirectly by means of the flexible device in the form of a flexible plate 38 (or a leaf spring or a leaf spring package) and bearing device 28 inside the stator housing 20 of the electric machine. The hollow shaft 41 is supported by means of a bearing arrangement 24 inside the rotatable housing 25. The rotatable housing 25, moreover, is connected non-rotatably with the likewise rotatable housing 23 of the power transmission device 6. The housing 23 of the power transmission device 6 is formed preferably by the housing part coupled non-rotatably with the impeller P, in particular impeller shell, which, under the formation of an axial interstice 26, encloses the turbine wheel T in axial direction, as well as in circumferential and radial direction. In this interstice 26, the arrangement of the device 10 in the form of the switchable clutch device is provided, in particular of the lock-up clutch.

The housing 23, which is executed in the form of a housing bell, forms a part of the housing 25 of the device 14 with a partial section of its housing wall. The housing 23 is connected in this area with a hub 30.

The electric machine 7 can be preassembled as a component unit, wherein it can be integrated inside the housing 27. The electric machine 7 comprises a rotor 12 and a stator 13, wherein the stator 13 encloses the rotor circumferentially in radial direction under the formation of an air gap 48. The embodiment as an assembly unit has the advantage that the efficiency-relevant gap 48 between the rotor 12 and the stator 13 can be minimized or at least be fabricated more accurately.

The rotor 12 of the electric machine 7 is connected non-rotatably with the rotatable housing 23 of the power transmission device 6 by means of its non-rotatable connection with the housing 25 and is moreover supported on the stator housing 20, which is supported either inside the housing 27 of the combined power transmission and drive unit 1 or in the case of a multi-part embodiment it is an integral component of the housing 27, at least indirectly, preferably directly. The support occurs by means of a bearing device 28. The arrangement of the electric machine 7 occurs preferably, when viewed in radial direction, such that it encloses the device 14 as a preassembly-capable component unit in radial and in circumferential direction, wherein the extension in axial direction, based on the viewing direction, between engine 3 and transmission 4 essentially around the axial extension of the device 14 in the form of a wet-running clutch device 15. The support is provided on a stationary housing part. In this way, it is further possible to execute the rotatable housing 23, 25 in a manner that is tight to pressure and liquid relative to the electric machine 7. This occurs in the simplest case by means of sealing devices, which can be executed both as axial and as radial seals. The sealing is provided in particular by means of sealing devices 44 between the pump neck 43 and housing 27 and sealing devices 46 between the input 33 of the combined power transmission and drive unit 1 and housing 25.

In analog, also the power transmission device 6 as well as the device 14 can be executed in a manner that is tight to pressure and liquid relative to one another. Individual components can be formed, preassembled and tested as separate components, in a simple manner. Further sealing devices serve as partition of individual pressure chambers.

Furthermore, the following are apparent: axial bearing 45 between housing 23 and transmission input shaft 5, in particular the hub 30 and elements of power transmission device 6, axial bearing 47 between the rotatable housing 25 of the device 14 as well as the first clutch part 15E and axial bearing 29 between the first clutch part 15E and transmission input shaft 5, in particular hub 30.

The transmission input shaft 5 is formed directly by an output shaft 22 forming the output of the power transmission device 6. Viewed in the power flow direction, according to the embodiment shown in FIG. 2, the latter is thereby disposed downstream of the device 10, in the form of a switchable clutch device as well as of the hydrodynamic component 8, by interposing an apparatus 19 for damping vibrations.

The hydrodynamic component 8, in particular the power transmission device 6 is supported in at least two points 31 through the pump neck 43 inside the housing 27 and through the flexible plate 38 together with the rotor 12 of the electric machine inside the stator housing 20, which is designated as mounting point 32. For this, the connection between the rotor 12 and power transmission device 6 around the housing 25 through the flexible plate 38, which is coupled by means of the means 39 with the housing 25. This elastic link allows axial mobility. Compensation of an axial and/or angular offset between the engine 3, in particular, and its crankshaft 21 and the transmission input shaft 5 occurs through the deflection of the housing from the middle alignment, so that it lies obliquely between 31 and 33.

The transmission input shaft 5 is hereby free from a support in the crankshaft 21. This means that the latter is not supported in the crankshaft 21, on the drive side, in normal traction operation—viewed in power flow direction. The coupling between the crankshaft 21 and the input 15E of the switchable clutch device 15 thereby occurs through the hollow shaft 41, which is connected non-rotatably with the clutch input 15E or forms the latter. This is supported inside the rotatable housing 25. The coupling of the rotatable housing 25 to the housing 23 occurs here for instance in the form of a non-detachable connection, in particular of a welded connection. However, considerable are also detachable connections in the form of screw connections. The bearing of the transmission input shaft 5 on the side of the engine 3 is provided through the housing 23 and the bearing of the latter inside the stator housing 20 or transmission housing 27.

The connection between the clutch input 15E of the wet-running disc clutch and the crankshaft 21 and hence the engine 3 is preferably not provided directly, but by means of an apparatus 16 for damping vibrations, for instance in the form of a dual mass flywheel, hydraulic damper, mechanical damper or combined hydraulic-mechanical damper. This comprises a primary part 35 and a secondary part 36, which are rotatable in circumferential direction relative to one another and are connected with one another by means of damping and means for torque transmission 17, 18. In this way is an elastic clutch formed, through which an angular and/or axial offset of the drive train parts to be connected can be aligned with one another. The coupling of the secondary part 36 with the device 14 takes place preferably force- or form-closed. Thus, the means for compensating axial offset or angular offset can be integrated in the apparatus 16 in a particularly advantageous manner.

The coupling with the crankshaft 21 occurs preferably force- or form-closed. This applies also to the coupling with the device 12. In a particularly advantageous embodiment, the connection between the engine 3 and the combined power transmission and drive unit 1 is realized by means of a stuck-in connection.

The switchable clutch device 15 in the depicted case is formed as disc clutch. The individual discs are brought together in active connection by means of a servo unit 15S. The servo unit 15S is formed as a piston element that is guided in a displaceable and pressure-tight manner relative to the transmission input shaft 5 and the housing 25 in the axial direction, wherein the guide can be provided either directly on the transmission input shaft 5 or on an element supported on the latter, in particular on a hub part 30 coupled non-rotatably with the housing 25. The piston element furthermore is guided in a sealing manner on the external disc carrier. In this way is a separate pressure chamber D15 formed for pressurizing the servo unit 15S. This features a connection to a tank—not depicted here—in order to relieve the seals outwardly. Furthermore, the pressure chamber D15 can be guided by means of targeted leakages from the piston chamber, thus the chamber in which the piston is guided or it can be filled from the power transmission device 6.

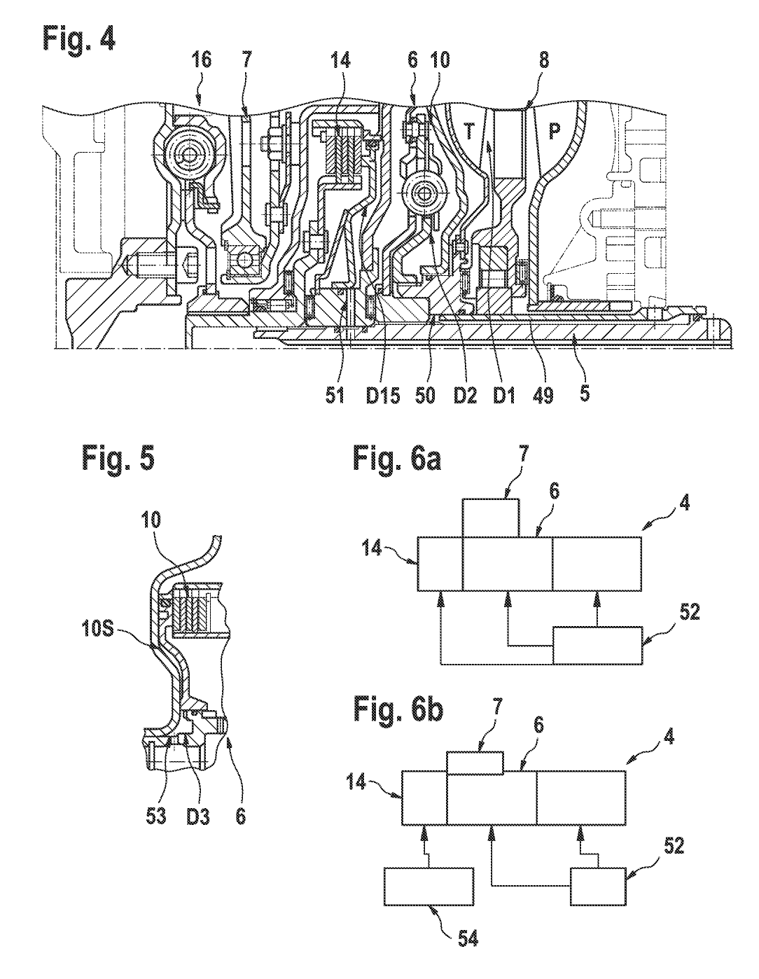

With respect to the embodiment of the hydrodynamic component 6 and the corresponding device 10 for at least partially bypassing the hydrodynamic power branch 9, in particular, the lock-up clutch there are a variety of possibilities. This is also associated with concrete functions and mode of operation of the power transmission device 6. The hydrodynamic rotation speed/torque converter or the hydrodynamic clutch can be executed, for this purpose, as is depicted in FIGS. 2 and 4 in dual-channel design or as exemplarily shown in FIG. 5 for the latter section in triple-channel design. The dual-channel design in accordance with FIGS. 2 and 4 is thereby characterized in that two pressure chambers are essentially formed within the power transmission device 6, which are designated with D1 and D2. The first pressure chamber D1 is thereby formed by the work chamber of the hydrodynamic component 8 between the impeller P and turbine wheel T. The second pressure chamber D2 corresponds to the internal chamber 26 enclosed by the housing 23. Both are assigned to corresponding connections 49 and 50.

Depending on activation of the hydrodynamic component 8 and fluid-flow direction, thus whether centripetal or centrifugal passage of the hydrodynamic component 8, a circuit is created, which also acts on the components of the switchable clutch device 10. In normal operation of the hydrodynamic component 8, thus power transmission through the latter, passage is preferably centripetal, thus, the operating means is brought from the external circumference area in radial direction into the work chamber of the hydrodynamic component 8. In this case, the fluid flow of the operating medium is used concurrently to keep the individual clutch parts 10E and 10A of the switchable clutch device apart and hence keep the clutch device in the deactivated state. In this operating manner, the power transmission occurs essentially through the hydrodynamic component 8 or fully through the latter. If now the fluid flow direction is reversed, in particular, the power transmission through the hydrodynamic component 8 is interrupted, owing to the pressure inside the interstice 26, which is then greater than that inside the work chamber of the hydrodynamic component 8, this is used concurrently to actuate the servo unit in 10S in the form of a piston element of the switchable clutch device. A separate piston is preferably omitted, in that the piston is used concurrently as clutch part 10A. In this manner is a frictional closure achieved and the lock-up clutch is closed.

As for an embodiment in triple-channel design in accordance with FIG. 5, this is characterized in that a separate pressure chamber D3 is provided for pressurizing the servo unit 105 of the device 10 for at least partially bypassing the hydrodynamic power branch 9 and this pressure chamber D3 can be activated to pressurize the servo unit 10S separately, i.e. independently of the pressure ratios in the remaining pressure chambers D1, D2 of the power transmission device 6.

The arrangement of all components takes place here, in axial direction, adjacently to one another, wherein, however, the arrangement of the electric machine occurs preferably such that, in radial direction, the internal diameter of the rotor 12, which is formed by a ring-shaped element, is free of component units, characterized by integration of component units, in particular through the integration of the wet-running clutch device 15. All drive-side parts of the switchable clutch device 15 are mounted on the front side of the housing 25.

In accordance with the embodiment shown in FIG. 2, the hydrodynamic component, in particular the power transmission device 6 and the device 14 are preassembled as units that are testable and mountable on the transmission shaft 5.

The depicted pressure chambers and seals are advantageous embodiments. It is obvious that, based on arrangement, the sealing devices and the desired relief effects can be provided on these additional channels.

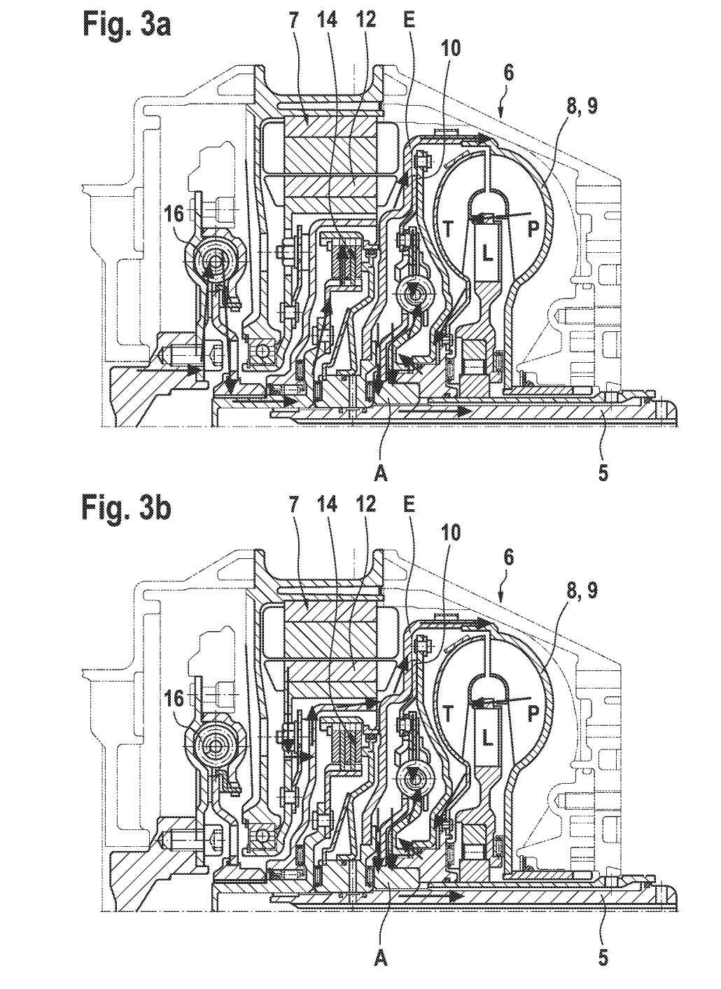

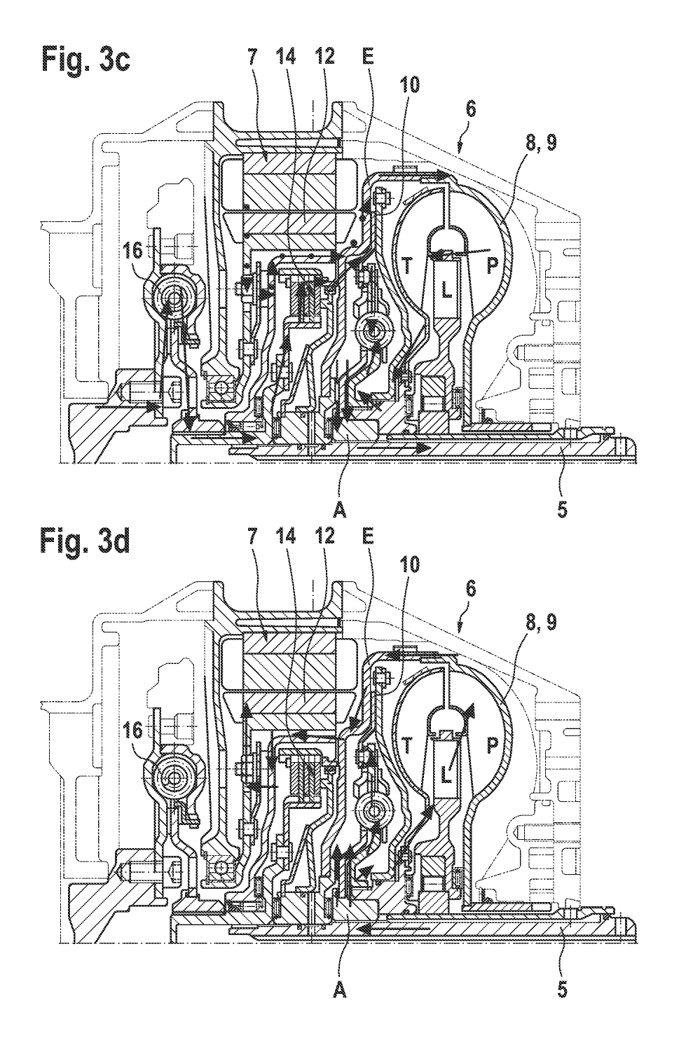

FIG. 3a illustrates the power flow when driving by the engine 3 alone, based on an embodiment in accordance with FIG. 2. The device 14 is closed and enables power flow to the power transmission device 6. In the latter, the power transmission based on the mode of operation occurs either through the hydrodynamic power branch 9, i.e. through the hydrodynamic component 8, or through the mechanical power branch 11, i.e. the device 10, clarified by means of dashed line. Parallel operation is also considerable, i.e. concurrent power transmission through both branches 9, 11.

FIG. 3b thereby clearly illustrates the power flow in a pure electric driving operation. In this case, the switchable clutch device 15 is deactivated. The power flow between engine 3 and transmission input shaft 5 is interrupted. The drive can in the process occur only through the electric machine 7. This, in particular the rotor, is thereby coupled non-rotatably with the input E in the form of housing 25 of the power transmission device, so that the power from the rotor of the electric machine is fed directly to the power transmission device 6 or rather into the impeller P of the hydrodynamic component 8. The turbine wheel T is driven via an element connected non-rotatably with the transmission input shaft 5, here through the apparatus 19 for damping vibrations. Furthermore, when driving electrically, also a mode of operation is possible by means of the power transmission device 6, which is characterized by power transmission through the second power branch 11. In this case is the device 10 closed, thus, the lock-up clutch is activated and the first power branch 9, thus, the hydrodynamic component is bypassed. The drive then occurs directly through the first clutch part 10E coupled non-rotatably, here force-closed, with the housing 25. The clutch 10 is connected through the apparatus 19 for damping vibrations likewise with the transmission input shaft 5. The coupling occurs here through non-rotatable coupling means 18 for torque transmission of the apparatus 19 for damping vibrations.

In an alternative function, the electric machine 7 in this configuration can also be used as a braking device, in that the latter can be operated in the counter flow principle.

In accordance with the embodiment shown in FIG. 3c, also a combined mode of operation comprising a mechanical drive and electric drive is possible. In this case, power transmission between the engine 3 and the power transmission device 6 is possible. The switchable clutch device 15 in the form wet-running clutch is ruled out. In addition, the drive here can be supported through the electric machine 7. Both engines 3, 7 operate in parallel, wherein the power transmission device 6 then almost acts as summation transmission.

In the embodiment in accordance with FIG. 3d it is provided that the electric machine 7 is operated in generator mode and hence it feeds electric power into an accumulator—not depicted here. This is, in particular, the case in combustion operation. Thus, in deceleration operation, that means, for power transmitted from the transmission input shaft 5, viewed in the direction towards the engine 3, the power in the power transmission device 6 is fed either through the hydrodynamic component 8 to the rotor 12 of the electric machine 7 or through the switchable clutch device 10 formed as a lock-up clutch.

In particular, in the mode of operation according to FIGS. 3a and 3c, this results in distribution of mass that is characterized by a primary mass and a secondary mass, wherein the primary mass is formed with an element coupled with the engine 3, and the secondary masses of the device 14, the rotor 12 and the power transmission device 6.

FIGS. 6a and 6b show, in schematically simplified illustration, the possibilities of activating the individual function units of the combined unit 1. Thus, here, the transmission is exemplarily assigned to an open-/closed-loop control 52. In a particularly advantageous embodiment, this is also provided for activating the combined power transmission and drive unit 1, in particular the power transmission device 6 and device 14.

On the other hand, FIG. 6b exemplarily illustrates an embodiment with separate activation of the device 14 by means of a special open-/closed-loop control 54. This can, for instance, take place from the engine control unit or also from a superior vehicle control unit, when the combined power transmission and drive unit 1 is used in vehicles.

FIGS. 1 to 6 depict particularly advantageous or preferred embodiments. The solution, according to the invention, of a combined power transmission and drive unit 1 comprising preassembled units is nonetheless not limited to the depicted embodiments. The embodiments can vary, for example, with respect to the arrangement of individual channels for relieving the seals. These are in general guided through the transmission input shaft to a tank.

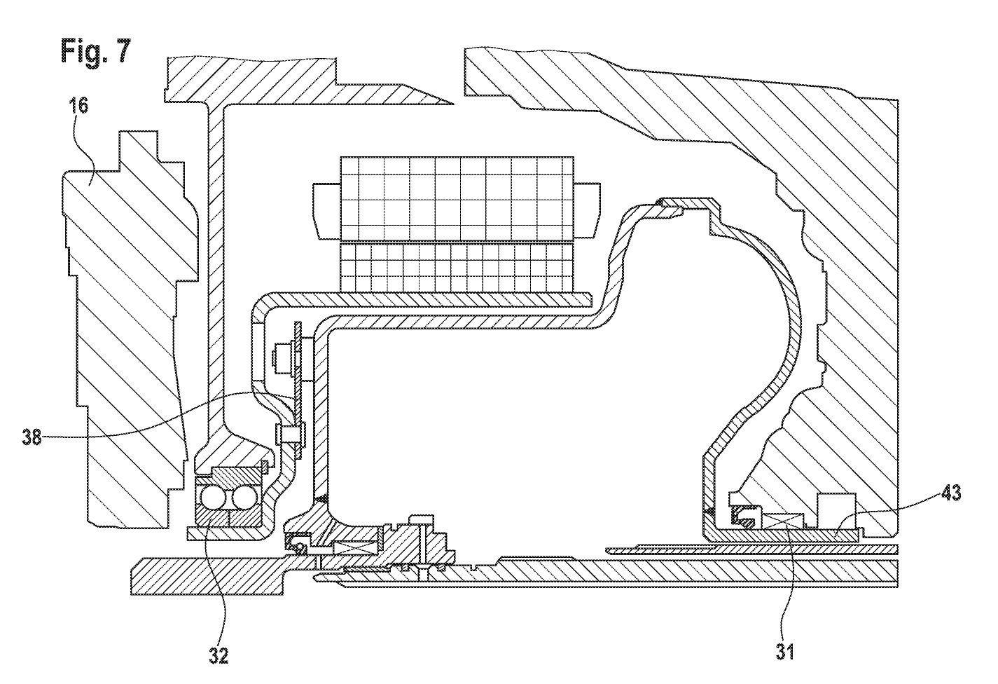

FIG. 7 shows, in a strongly schematized form, the present hybrid system with a bearing of the rotor in accordance with the exemplary embodiments of FIGS. 1 to 6b. From FIG. 7 is the basic design apparent with dual mass flywheel 16, transmission housing, electric machine and power transmission device. With regard to the schematization, in particular, all components within the housing of the power transmission device were faded out in order to be able to better concentrate on the bearing of the rotor of the electric machine.

As is apparent, the rotor (or rotor plate) on the engine side is supported by the bearing 32 (rotor bearing) in the transmission housing. Therefore, the rotor plate is supported by the bearing 32 on one side (engine side). The bearing 32 is provided as a roller bearing, such as a double-row ball-bearing or depending upon the respective design of the power transmission systems, as a single-row ball bearing.

The rotor plate is additionally connected by means of a flexible connection such as a flexible plate or a similar connection, in particular one or several leaf spring connections (respectively a single leaf spring or a leaf spring package), with the converter housing, wherein the flexible plate on the rotor plate is attached by riveting, and on the converter housing by means of a screw connection. Through this flexible plate-connection is the rotor plate centered relative to the housing.

The converter is supported by the bearing 31 (pump neck bearing) inside the transmission housing. A needle bearing is provided in this case as bearing 31. The pump neck bearing can also be in the form of a plain bushing or a plain bearing.

In accordance with the exemplary embodiment based on FIG. 7, the rotor plate is connected by means of a flexible plate or a similar connection, like leaf spring, with the converter housing and the rotor plate is supported on the engine side by the rotor bearing.

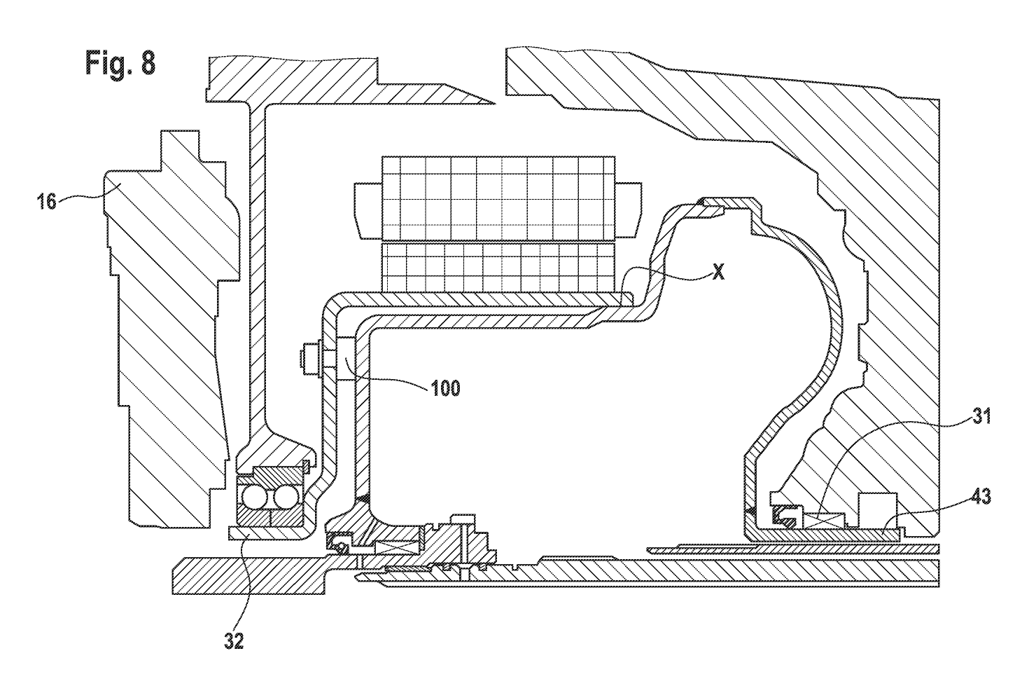

FIG. 8 shows, in a strongly schematized form, the present hybrid system with a modified bearing of the rotor (rotor plate). As is apparent, the bearing of the rotor of the electric machine is modified in that the rotor plate is supported on the converter housing and hence it is centered. This newly introduced bearing point is designated in FIG. 8 with the character X. The flexible plate connection can be omitted. The converter housing and the rotor plate are supported by the rotor bearing and the pump neck bearing on the transmission housing. What is advantageous in this arrangement is that rotor bearing is also provided with a second bearing on the pump neck (pump neck bearing). This results in little forces on the rotor bearing. Besides this, exact centering of the rotor and of the converter is achieved.

The rotor plate bearing on the converter housing can be designed also as serration in order to transmit torque.

In this case is the converter housing expanded in the area around this new bearing point X and it has direct contact with the rotor plate. Alternatively, it could be tapered to adapt it to the rotor plate in order to contact the converter housing. A further alternative could involve modifying both the design of the rotor plate as well as the design of the converter housing, in order to form a corresponding contact point. Yet another alternative for the same or modified design of the rotor plate and/or of the converter housing, a spacing element could be provided between the rotor plate and the converter housing, wherein the spacing element can form both a rigid connection as well as a radially and/or axially somewhat flexible connection. The spacing element can also form a sliding connection (plain bearing/sliding coating).

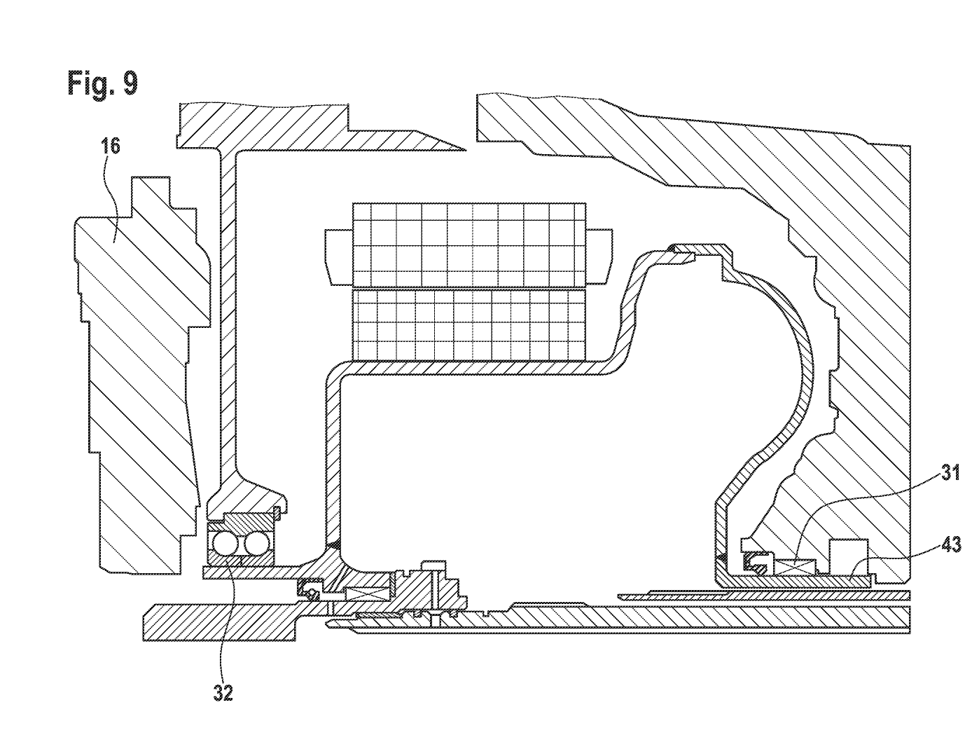

Owing to this new bearing point X, the flexible plate connection in accordance with FIG. 7 can be omitted. A buffer element 100 is disposed accordingly, in FIG. 8, between the rotor plate and converter housing, which in deed provides an axially acting support. The mechanical connection between the rotor plate and the converter housing occurs through the buffer element, basically for transmitting torque and axial forces. In combination with the serration between the rotor plate and converter housing, the connection through the buffer element only serves for transmitting axial forces. In spite of concrete embodiment of the connection in accordance with FIG. 8, such a connection must be suitable for the exemplary embodiment according to FIG. 8, for the transmission of torque and axial forces. This does not apply to the exemplary embodiment according to FIG. 7, since the flexible plate connection does not transmit significant axial forces. For exemplary embodiment according to FIG. 9, such a connection is not necessary.

In accordance with the exemplary embodiment according to FIG. 8, the converter housing is supported directly and the rotor plate indirectly through the pump neck bearing 31. Moreover the converter housing is supported indirectly and the rotor plate directly by the rotor bearing 32 on the transmission housing. An axial support of the converter housing occurs through the buffer element 100.

In this case, a fixed bearing 32 is provided on the engine side and a loose bearing 31 on the transmission side. This bearing concept can be turned around so that a loose bearing is provided on the engine side and a fixed bearing would be provided on the transmission side. In addition, also two fixed bearings could be provided since the bearing point X and/or the buffer element provide axial compensation possibility.

In accordance with FIGS. 1 to 7, the rotor plate is thus connected/centered by means of a screw connection to the converter housing. The rotor plate is supported on one side. This will be modified in the exemplary embodiment in accordance with FIG. 8, in that the rotor plate is centered on the converter housing. What is advantageous in this embodiment is that the bearing of the rotor is also provided by a second bearing on the pump neck (pump neck bearing). In this way, smaller forces are incurred on the rotor bearing. Furthermore, a more exact centering effect of the rotor and converter is attained.

In FIG. 9, in a strongly schematized form, a further exemplary embodiment of the present hybrid system is shown, wherein the rotor is attached directly on the converter housing. The separate rotor plate, the bearing point X and the buffer element are no longer available in this formation. The other features of the exemplary embodiment according to FIG. 9 correspond to the features of the exemplary embodiment according to FIG. 8.

Since the rotor is fixed directly on the converter housing, it is supported and centered through the latter. The converter housing is additionally supported on the pump neck bearing by means of a pilot through the rotor bearing (roller bearing). In this design, it is advantageous that the rotor plate can be omitted. Therefore, a larger radial assembly space is available between the stator and converter housing. Moreover, an optimized bearing/centering of the converter housing is attained by means of the bearing on the engine side.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

### LIST OF REFERENCE SYMBOLS

1 combined power transmission and drive unit
2 hybrid system
3 engine
4 transmission
5 transmission input shaft
6 power transmission device
7 electric machine
8 hydrodynamic component
9 first power branch
10 device for bypassing of the first power branch
11 second power branch
12 rotor
13 stator
14 device for connecting/disconnecting the power flow
15 switchable clutch device
15E clutch input
15A clutch output
16 apparatus for damping vibrations
17 means for coupling damping
18 means for power transmission
19 apparatus for damping vibrations
20 stator housing
21 crankshaft
22 output shaft
23 rotatable housing
24 bearing arrangement
25 housing
26 interstice
27 transmission housing
28 bearing device
29 axial bearing
30 hub
31 bearing point
32 bearing point
33 input of the combined power transmission and drive unit
34 output of the combined power transmission and drive unit
35 primary part
36 secondary part
37 hub
38 flexible plate
39 connection means
40 drive train
41 hollow shaft
42 hub
43 pump neck
44 sealing device
45 axial bearing
46 sealing device
47 axial bearing
48 air gap
49 connection
50 connection
51 connection
52 open-/closed-loop control
53 connection
54 open-/closed-loop control
P impeller
T turbine wheel
E input
A output
R rotation axis
D1 pressure chamber
D2 pressure chamber
D3 pressure chamber
D15 pressure chamber

What we claim is:

1. A combined power transmission and drive unit (1) for the application in hybrid systems (2) between a first engine (3) and a transmission device, in particular transmission (4), comprising at least an input (33) capable of connection with the first engine (3), a power transmission device (6), by which an output (A) is connected with a transmission input shaft (5) and an electric machine (7), comprising at least a rotor (12) that is connected non-rotatably with an input (E) of the power transmission device (6), wherein the rotor is supported on a housing of the power transmission device.

2. The combined power transmission and drive unit (1) according to claim 1, wherein a bearing of the rotor or a part of the rotor is connected with the rotor non-rotatably also through the housing, and thus by means of a second bearing on a neck (43) of a pump (P) of the power transmission device (6).
